(19) United States
(12) Patent Application Publication
(10) Pub. No.: US 2018/0217810 A1
(43) Pub. Date: Aug. 2, 2018

(54) CONTEXT BASED VOICE COMMANDS

(71) Applicant: Motorola Mobility LLC, Chicago, IL (US)

(72) Inventor: Amit Kumar Agrawal, Bangalore (IN)

(21) Appl. No.: 15/833,423

(22) Filed: Dec. 6, 2017

(30) Foreign Application Priority Data
Jan. 27, 2017 (IN) 201731003127

(51) Int. Cl. G06F 3/16; G10L 15/06; G10L 15/22; G10L 15/19; G06F 3/0488; G06F 3/0482

(52) U.S. Cl. CPC G06F 3/167; G10L 15/063; G10L 15/22; G10L 2015/223; G06F 3/0488; G06F 3/0482; G10L 2015/0635; G10L 15/19

(57) ABSTRACT

A method includes detecting a selection of a first control in an application executed by a device. A voice grammar list associated with the first control is generated responsive to detecting the selection. An audio sample received over a microphone of the device is analyzed to identify a voice command matching an item in the voice grammar list. The voice command is executed. A device includes a display, a microphone, a touch sensor to detect interactions with the display, and a processor coupled to the touch sensor and the microphone. The processor is to detect a selection of a first control in an application executed by the device, generate a voice grammar list associated with the first control responsive to detecting the selection, analyze an audio sample received over the microphone to identify a voice command matching an item in the voice grammar list, and execute the voice command.

### BACKGROUND

### Field of the Disclosure

The disclosed subject matter relates generally to mobile computing systems and, more particularly, to providing context based voice commands based on user selections.

### Description of the Related Art

Many mobile devices allow user interaction through natural language voice commands to implement a hands-free mode of operation. Typically, a user presses a button or speaks a “trigger” phrase to enable the voice controlled mode. It is impractical to locally store a large library on the mobile device to enable the parsing of voice commands. Due to the large number of possible voice commands, captured speech is typically sent from the mobile device to a cloud-based processing resource, which performs a speech analysis and returns the parsed command. Due to the need for a remote processing entity, the service is only available when data connectivity is available.

The present disclosure is directed to various methods and devices that may solve or at least reduce some of the problems identified above.

### BRIEF DESCRIPTION OF THE DRAWINGS

The present disclosure may be better understood, and its numerous features and advantages made apparent to those skilled in the art by referencing the accompanying drawings.

FIG. 1 is a simplified block diagram of a mobile device operable to employ context based voice commands to allow a user to interact with a device using both touch and voice inputs, according to some embodiments disclosed herein;

FIG. 2 is a flow diagram of a method for employing context based voice commands to allow a user to interact with a device using both touch and voice inputs, in accordance with some embodiments; and

FIGS. 3-6 are front views of the mobile device of FIG. 1 illustrating voice and touch interaction events, according to some embodiments disclosed herein.

The use of the same reference symbols in different drawings indicates similar or identical items.

### DETAILED DESCRIPTION OF EMBODIMENT(S)

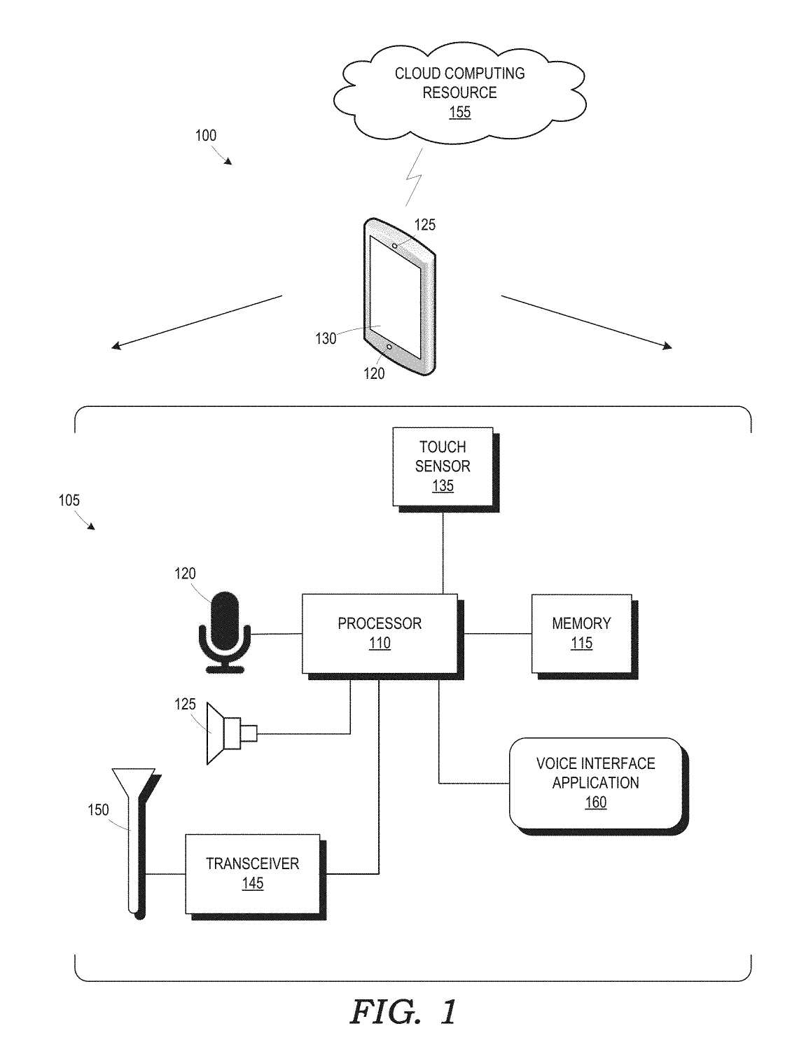

FIGS. 1-6 illustrate example techniques for employing context based voice commands to allow a user to interact with a device using both touch and voice inputs. A user may interact with a touch sensor integrated with a display of the device. Based on the user's touch interaction (e.g., selecting a particular item on the display), the device may generate a context sensitive list of potential voice commands and listen for a subsequent voice command. Because the context sensitive list is limited in size, the device may locally parse the voice command.

FIG. 1 is a simplistic block diagram of a device 100, in accordance with some embodiments. The device 100 implements a computing system 105 including, among other things, a processor 110, a memory 115, a microphone 120, a speaker 125, a display 130, and a touch sensor 135 (e.g., capacitive sensor) associated with the display 130. The memory 115 may be a volatile memory (e.g., DRAM, SRAM) or a non-volatile memory (e.g., ROM, flash memory, hard disk, etc.). The device 100 includes a transceiver 145 for transmitting and receiving signals via an antenna 150 over a communication link. The transceiver 145 may include one or more radios for communicating according to different radio access technologies, such as cellular, Wi-Fi, Bluetooth®, etc. The communication link may have a variety of forms. In some embodiments, the communication link may be a wireless radio or cellular radio link. The communication link may also communicate over a packet-based communication network, such as the Internet. In one embodiment, a cloud computing resource 155 may interface with the device 100 to implement one or more of the functions described herein.

In various embodiments, the device 100 may be embodied in a handheld or wearable device, such as a laptop computer, a handheld computer, a tablet computer, a mobile device, a telephone, a personal data assistant, a music player, a game device, a wearable computing device, and the like. To the extent certain example aspects of the device 100 are not described herein, such example aspects may or may not be included in various embodiments without limiting the spirit and scope of the embodiments of the present application as would be understood by one of skill in the art.

In the device 100, the processor 110 may execute instructions stored in the memory 115 and store information in the memory 115, such as the results of the executed instructions. Some embodiments of the processor 110 and the memory 115 may be configured to implement a voice interface application 160. For example, the processor 110 may execute the voice interface application 160 to generate a context sensitive list of potential voice commands and identify voice commands from the user associated with user touch events on the device 105. One or more aspects of the techniques may also be implemented using the cloud computing resource 155 in addition to the voice interface application 160.

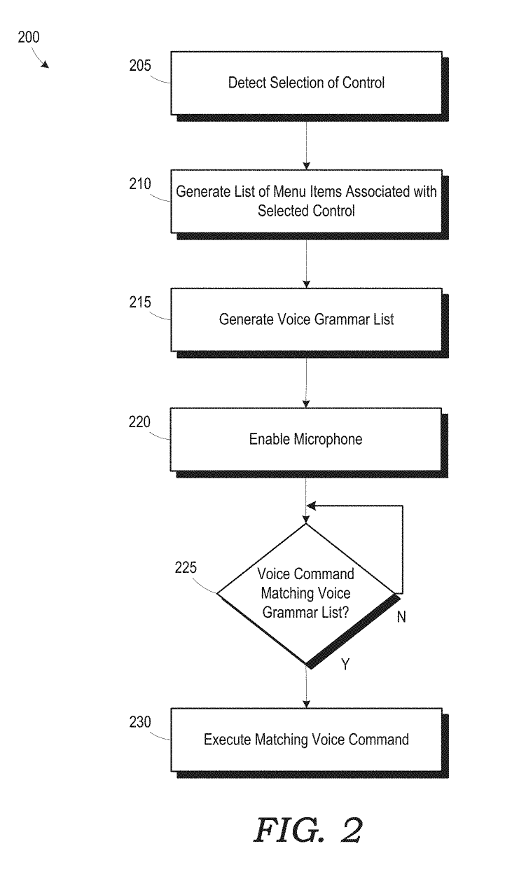

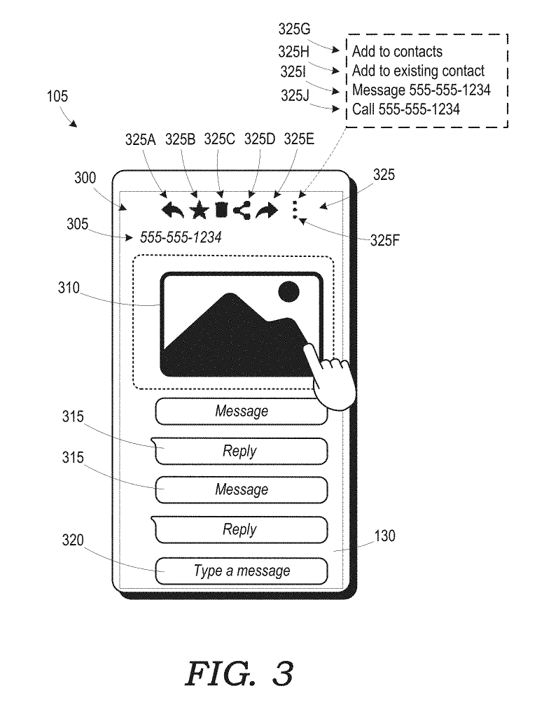

FIG. 2 is a flow diagram of a method 200 for employing context based voice commands to allow a user to interact with a device using both touch and voice inputs, in accordance with some embodiments. FIGS. 3-6 are front views of the mobile device 105 of FIG. 1 illustrating voice and touch interaction events as described in conjunction with the method 200 of FIG. 2.

In method block 205, the voice interface application 160 detects a selection of a control in an application 300 executed by the device 105. In the illustrated example, the application 300 is a messaging application, however, the application or the present subject matter is not limited to a particular type of application. Any type of application 300 may be employed, including user-installed applications or operating system applications. Example controls provided by the illustrated application 300 include a party identifier control 305 (e.g., phone number or name if the phone number corresponds to an existing contact), an image control 310, a message control 315, a text input control 320, etc. The particular types of controls employed depend on the particular application. The application of the present subject matter is not limited to a particular type of control. In general, a control is considered an element displayed by the application 300 that may be selected by touching the display 130.

In method block 210, the application 300 generates a list of menu items for the application 300 associated with the selected control 310. As shown in FIG. 3, the user has selected an image control 310 on the display 130 (as registered by the touch sensor 135 (see FIG. 1). Responsive to the selection of the control 310, the application 300 generates a menu 325 that may be accessed by the user to invoke an action associated with the selected control 310. The particular elements on the menu 325 may vary depending on the particular control selected. In the example of FIG. 3, the menu 325 includes a REPLY menu item 325A for responding to the other party participating in the messaging thread, a STAR menu item 325B for designating the selected control 310 as important, A DELETE menu item 325C for deleting the selected control 310, a SHARE menu item 325D for sharing the selected control 310 (e.g., posting the control 310 on a different platform, such as a social media platform), a FORWARD menu item 325E for forwarding the selected control to another party, and a MORE menu item 325F indicating that additional hidden menu items are available, but not currently shown on the display 130. In the illustrated example, the example hidden menu items include an ADD TO CONTACTS menu item 325G for adding the party to the user's contact list, an ADD TO EXISTING CONTACT menu item 325H for adding the party to an existing entry in the user's contact list, a MESSAGE menu item 325I for sending a text message to the party, and a CALL menu item 325J for calling the party. In some embodiments, some of the other menu items 325A-325D may also have hidden or sub-menu menu items associated with them. For example, the SHARE menu item 325D may have sub-menus indicating a list of services to which the item may be shared (e.g., FACEBOOK®, INSTAGRAM®, SNAPCHAT®, etc.).

In some embodiments, the application 300 defines a list of current menu items to be displayed on the current screen in a resource file within the operating system. The voice interface application 160 may be a system privileged application that can query the application framework to fetch the menu items registered by the application 300 for the currently populated display. Since the menus are dynamically populated by the application 300, there is no need for the voice interface application 160 to have a priori knowledge of the menu items employed by the application 300 or even knowledge of the particular type of control 310 selected by the user.

In method block 215, the voice interface application 160 generates a voice grammar list based on the list of menu items. For example, the voice grammar list for the menu 325 in FIG. 3 includes the entries:
REPLY
STAR
DELETE
SHARE
SHARE ON SERVICE (e.g., share on FACEBOOK®)
FORWARD
ADD TO CONTACTS
ADD TO EXISTING CONTACTS
TEXT
CALL

In method block, 220, the voice interface application 160 enables the microphone 120 responsive to the selection of the control 310. In some embodiments, the microphone 120 may be enabled continuously (Always on Voice (AoV)), while in other embodiments, the voice interface application 160 enables the microphone 120 for a predetermined time interval after the selection of the control 310 to monitor for a voice command. Selectively enabling the microphone 120 reduces power consumption by the device 105. In addition, the selective enabling of the microphone 120 based on the user touch interaction avoids the need for a voice trigger, thereby simplifying the user experience.

In method block 225, the voice interface application 160 analyzes an audio sample received over the microphone 120 to identify a voice command matching an item in the voice grammar list. In some embodiments, since the number of candidate voice commands is relatively low, the voice interface application 160 may locally process the audio sample to identify a voice command matching the voice grammar list. In other embodiments, the voice interface application 160 may forward the audio sample to the cloud computing resource 155, and the cloud computing resource 155 may analyze the audio sample to identify any voice commands. The voice interface application 160 may receive any parsed voice commands and compare them to the voice grammar list to identify a match. In some embodiments, the voice interface application 160 may send both the voice grammar list and the audio stream sample to the cloud computing resource 155 and receive a matched voice command.

In method block 230, the voice interface application 160 executes the matching voice command. In some embodiments, the voice interface application 160 may simulate a touch by the user on the menu 325 by directly invoking a call for the menu items 325A-J registered by the application 300. The context generated by the user's selection/touch (e.g., image, video, text, etc.) is employed to simplify the identification and processing of the subsequent voice command without requiring an explicit designation by the user.

If the user does not voice a command after selecting the control 310, the voice interface application 160 takes no actions. If the user selects a new control, the voice interface application 160 flushes the voice grammar list and repopulates it with the new list of menu items registered by the application.

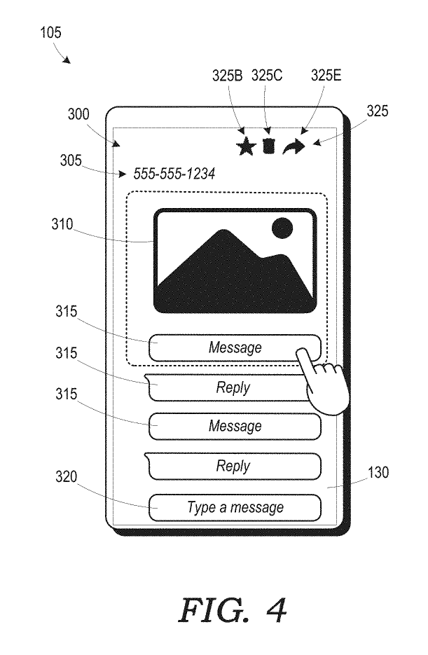

In some embodiments, the user may select more than one control on the display 130. For example, as illustrated in FIG. 4, the user may select the image control 310 and a message control 315. The application 300 may define a different menu 325 when multiple controls are selected. In the example of FIG. 4, the menu 325 includes only the STAR control 235B, the DELETE control 325C, and the FORWARD control 325E. The voice interface application 160 may determine that the application has changed its registered menu items after the subsequent touch event that selects multiple controls and reduce the number of items in the voice grammar list accordingly.

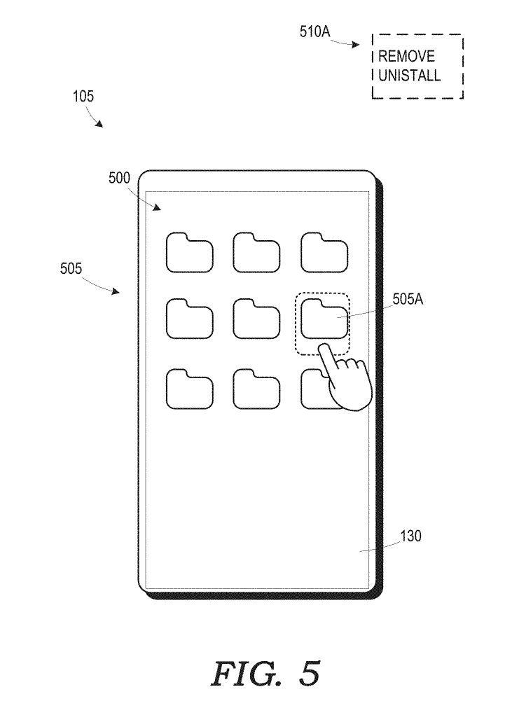

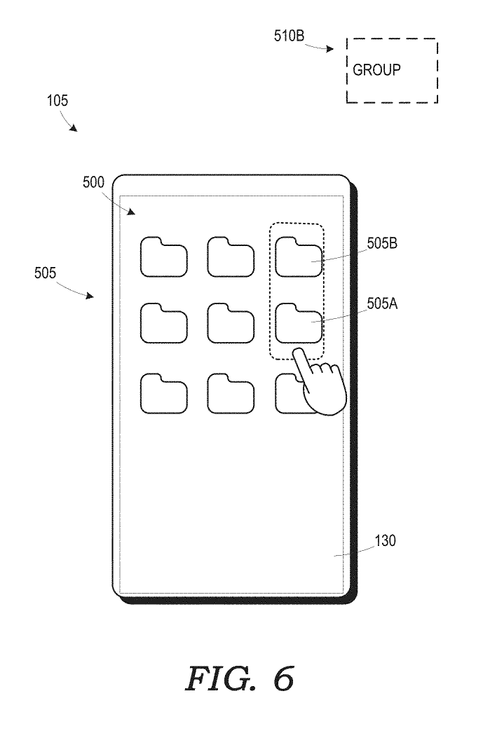

In another example illustrated in FIG. 5, a user interface application 500 may display a plurality of application icons 505 that may be launched by the user. If the user selects a particular icon 505A (e.g., using a long touch), the application 500 may allow the user to REMOVE or UNINSTALL the associated application. Accordingly, the voice interface application 160 populates a voice grammar list 510A with these items. If the user selects two or more application icons, 505A, 505B, as illustrated in FIG. 6, the application 500 may allow the user to GROUP the selected applications, and the voice interface application 160 populates a voice grammar list 510B with these items.

In some embodiments, certain aspects of the techniques described above may be implemented by one or more processors of a processing system executing software. The techniques described herein may be implemented by executing software on a computing device, such as the processor 110 of FIG. 1, however, such methods are not abstract in that they improve the operation of the device 100 and the user's experience when operating the device 100. Prior to execution, the software instructions may be transferred from a non-transitory computer readable storage medium to a memory, such as the memory 115 of FIG. 1.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium may include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

A method includes detecting a selection of a first control in an application executed by a device. A voice grammar list associated with the first control is generated responsive to detecting the selection. An audio sample received over a microphone of the device is analyzed to identify a voice command matching an item in the voice grammar list. The voice command is executed.

A method includes detecting a selection of a first control in an application executed by a device. A list of menu items generated by the application is extracted responsive to detecting the selection. A voice grammar list is generated based on the list of menu items. A microphone of the device is enabled for a predetermined period of time after detecting the selection. An audio sample received over the microphone is analyzed to identify a voice command matching an item in the voice grammar list. The voice command is executed.

A device includes a display, a microphone, a touch sensor to detect interactions with the display, and a processor coupled to the touch sensor and the microphone. The processor is to detect a selection of a first control in an application executed by the device, generate a voice grammar list associated with the first control responsive to detecting the selection, analyze an audio sample received over the microphone to identify a voice command matching an item in the voice grammar list, and execute the voice command.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

What is claimed is:

1. A method, comprising:
detecting a selection of a first control in an application executed by a device;
generating a voice grammar list associated with the first control responsive to detecting the selection;
analyzing an audio sample received over a microphone of the device to identify a voice command matching an item in the voice grammar list; and
executing the voice command.

2. The method of claim 1, wherein generating the voice grammar list comprises generating the voice grammar list based on a list of menu items registered by the application.

3. The method of claim 2, wherein the list of menu items comprises at least one hidden menu item.

4. The method of claim 2, wherein the list of menu items comprises at least one sub-menu item.

5. The method of claim 1, further comprising:
detecting a selection of the first control and a second control in the application; and
generating the voice grammar list associated with the first and second controls.

6. The method of claim 1, further comprising:
detecting a selection of a second control in the application and a deselection of the first control; and
updating the voice grammar list based on the selection of the second control.

7. The method of claim 2, wherein executing the voice command comprises simulating a touch input of a matching menu item.

8. The method of claim 1, further comprising enabling the microphone for a predetermined period of time after detecting the selection.

9. A method, comprising:
detecting a selection of a first control in an application executed by a device;
extracting a list of menu items generated by the application responsive to detecting the selection;
generating a voice grammar list based on the list of menu items;
enabling a microphone of the device for a predetermined period of time after detecting the selection;
analyzing an audio sample received over the microphone to identify a voice command matching an item in the voice grammar list; and
executing the voice command.

10. The method of claim 9, wherein the list of menu items comprises at least one menu item not shown by the application on the display.

11. The method of claim 9, further comprising:
detecting a selection of the first control and a second control in the application;
updating the list of menu items generated by the application responsive to detecting the selection of the first and second controls; and
updating the voice grammar list based on the updated list of menu items.

12. The method of claim 9, wherein executing the voice command comprises simulating a touch input of a matching menu item.

13. A device, comprising:
a display;
a microphone;
a touch sensor to detect interactions with the display; and
a processor coupled to the touch sensor and the microphone to detect a selection of a first control in an application executed by the device, generate a voice grammar list associated with the first control responsive to detecting the selection, analyze an audio sample received over the microphone to identify a voice command matching an item in the voice grammar list, and execute the voice command.

14. The device of claim 13, wherein the processor is to generate the voice grammar list based on a list of menu items registered by the application.

15. The device of claim 14, wherein the list of menu items comprises at least one hidden menu item.

16. The device of claim 14, wherein the list of menu items comprises at least one sub-menu item.

17. The device of claim 13, wherein the processor is to detect a selection of the first control and a second control in the application and generate the voice grammar list associated with the first and second controls.

18. The device of claim 13, wherein the processor is to detect a selection of a second control in the application and a deselection of the first control and update the voice grammar list based on the selection of the second control.

19. The device of claim 14, wherein the processor is to execute the voice command by simulating a touch input of a matching menu item.

20. The device of claim 13, wherein the processor is to enable the microphone for a predetermined period of time after detecting the selection.
